(19) United States
(12) Patent Application Publication
(10) Pub. No.: US 2009/0327730 A1
(43) Pub. Date: Dec. 31, 2009

(54) APPARATUS AND METHOD FOR ENCRYPTED COMMUNICATION PROCESSING

(75) Inventor: Satoshi DEISHI, Ibaraki-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/105,684

(22) Filed: Apr. 18, 2008

(30) Foreign Application Priority Data
Apr. 25, 2007 (JP) 2007-115298

(51) Int. Cl. H04L 9/32

(52) U.S. Cl. 713/171

(57) ABSTRACT

To provide an apparatus and a method for encrypted communication processing having a high communication speed in inter-node communication on a network capable of performing effective encrypted communication with improved security without losing the high speed. In the inter-node communication on the network, a plurality of shared encryption keys are first set and are switched arbitrarily for each packet to be transmitted, thus there is no need to repeat the handshaking for changing, whenever needed, the encryption keys to be used.

This application is based on Japanese Patent Application No. 2007-115298 filed on Apr. 25, 2007, in Japanese Patent Office, the entire content of which is hereby incorporated by reference.

### TECHNICAL FIELD

The present invention relates to an apparatus and a method for executing encrypted communication between encrypted communication processing apparatuses constituting a network as a node.

### BACKGROUND

In recent years, a network having a communication form for freely transmitting and receiving data between any nodes constituting the network has been used actively.

As a typical form, there is available a form of communication network called P2P (Peer to Peer). The P2P is a form of usage of a network for transmitting and receiving information directly between an indefinite number of nodes, and some forms of the P2P technically needs an intermediation of a central server or uses a bucket relay system to transfer data.

In a network form of such a distributed processing, every time a direct connection between any nodes is established to transmit and receive data, a procedure for that connection is necessary to be done. This decreases the communication efficiency, and the communication speed is generally apt to be affected adversely. On the other hand, if a procedure for freely executing communication between any nodes is made as simple as possible in order to raise the communication efficiency, the danger to security such as interception of communication by a third party is apt to increase.

For example, as a typical communication protocol used for the Internet, there are the TCP (Transmission Control Protocol) and UDP (User Datagram Protocol), and they have advantages and disadvantages as mentioned above. To be specific, the TCP is excellent in security and credibility, however, due to its procedures, high speed of communication can be hardly realized. Further, although the UDP has a high communication speed, the security and reliability of communication are low because the procedures are simplified for that purpose.

To enhance the security of communication, the encryption process is often used generally. In a high-speed communication protocol such as the UDP, the security of communication may be enhanced by adding the encryption process.

As an encrypted communication protocol which is often used generally, the IPsec (security architecture for internet protocol) and SSL (secure socket layer) may be cited, however, these are the protocols that effectively function on the TCP having a low communication speed.

As it is difficult to perform an effective encryption process by keeping high-speed of communication, an art for enhancing the security without using encryption is proposed (for example, refer to Unexamined Japanese Patent Application Publication 2005-303784).

The art disclosed in Unexamined Japanese Patent Application Publication 2005-303784 identifies the communication partner by confirming the ID of the correspondent node accessed for communication and rejecting the ID if it is not the predetermined ID. However, it is easy to spoof by acquiring the ID through Brute force attack or capturing packet. Further, since it is not an encryption process, it can easily get into the communication contents by spoofing.

Also in a protocol having a high communication speed like the UDP, an encryption process functioning without complicating so much the procedures is desirable, however, as such an encryption processing method, the encryption process using a fixed shared key has been conventionally used.

In the encryption processing technology using the fixed shared key, the nodes on the transmitting and receiving sides hold a shared encryption key (that is, the same key is used for encryption and decryption) and the key is fixed and unchanged.

However, there are problems that the shared key is easy to guess the shared key because it is always the same in the encryption processing method using the fixed shared key, or the communication can be easily intercepted by using an encryption processing.

There is desired an encryption processing technology that improves the security without complicating the procedures, in other words, without reducing the communication speed as far as possible.

As mentioned above, the communication speed and security is hardly consistent with each other in the inter-node communication on the network. Although it is desirable to execute communication by using encryption for security, it is difficult to perform the effective encrypted communication processing while keeping high communication speed.

### SUMMARY

An object of the present invention is to solve the aforementioned problems and to provide an encrypted communication processing method and an encrypted communication processing apparatus as a node. The method and apparatus are capable of an effective encrypted communication having a high communication speed with improved security in inter-node communication on a network.

In view of forgoing, one embodiment according to one aspect of the present invention is a method for encrypted communication process for performing encrypted communication between a plurality of nodes constituting a network system, the method comprising the steps of:

determining a message number between a first node and the second node;

causing the first node to authenticate the second node;

communicating a first information for generating an encryption key between the first node and the second node when the first node has successfully authenticated the second node;

generating a plurality of encryption keys based on the first information to share the encryption keys between the first node and the second node;

causing the first node to encrypt a second information based on an encryption key selected from the plurality of the encryption keys and to transmit to the second node a message and the message number, the message including the encrypted second information; and

causing the first node to change the encryption key for encryption.

According to another aspect of the present invention, another embodiment is an encrypted communication processing apparatus as a node of a network system for performing encrypted communication between a plurality of nodes, the apparatus comprising:

a determination section which is adapted to determine a message number between the apparatus and another node;

an authentication section which is adapted to authenticate the another node based on a first information received from the another node;

an encryption key generating section which is adapted to, when the another node has been successfully verified, communicate a second information for generating an encryption key to the another node, to generate a plurality of encryption keys based on the second information, and to share the encryption keys between the apparatus and the another node;

an encrypting section which is adapted to encrypt a third information based on an encryption key selected from the plurality of encryption keys shared between the apparatus and the another node, and to transmit a message and the message number to the another node, the message including the encrypted third information;

a change section which is adapted to change the encryption key used for encryption by the encrypting section.

### BRIEF DESCRIPTION OF THE DRAWINGS

FIG. 1 is a drawing showing an entire constitution example of a network 1 according to an embodiment of the present invention;

FIG. 2 is a drawing showing a hardware constitution example of a node (encrypted communication processing apparatus) 2 constituting the network 1 according to the embodiment of the present invention;

FIG. 3 is a drawing showing a connection form of each of the nodes 2 constituting the network 1 according to the embodiment of the present invention, that is, a theoretical topology example of the nodes;

FIG. 4 is a drawing showing the examples of the connection table TL of the nodes 2 associated as shown in FIG. 3;

FIG. 5a is a block diagram showing a function constitution example of the node (encrypted communication processing apparatus) 2;

FIG. 5b is a drawing showing an internal constitution of the function of a authentication section 205;

FIG. 6 is a sequence diagram for describing a processing example when establishing connection of SSL communication in the embodiment of the present invention;

FIG. 7 is a flow chart showing a typical flow of the encrypted communication processing from establishment of encrypted communication according to the embodiment of the present invention to the encryption processing and transmission of data;

FIG. 8 is a sequence diagram showing a detailed flow of the processing example of the connection step shown in FIG. 7;

FIG. 9 is a sequence diagram showing a detailed flow of the processing example of the authentication step shown in FIG. 7;

FIG. 10 is a sequence diagram showing a detailed flow of the processing example of the encryption key generating step shown in FIG. 7;

FIG. 11 is a sequence diagram showing a detailed flow of the processing example of the encryption step shown in FIG. 7;

FIG. 12a is a drawing, in the embodiment of the present invention, showing the state that the message Nos. and shared keys are stored in the memory in the case where transmission from the PC1 is executed;

FIG. 12b is a drawing, in the embodiment of the present invention, showing the state that the message Nos. and shared keys are stored in the memory in the case where transmission from the PC2 is executed; and

FIG. 12c is a drawing, in the embodiment of the present invention, showing the state that the message Nos. and shared keys are stored in the memory in the case where transmission between the PC1 and the case are executed; and

FIG. 13 is an illustration showing an example of actual data transmission by the encrypted communication processing according to the embodiment of the present invention.

### DETAILED DESCRIPTION OF THE PREFERRED EMBODIMENT

Hereinafter, the embodiment of the present invention will be explained with reference to the accompanying drawings.

### [Entire Constitution of the Network]

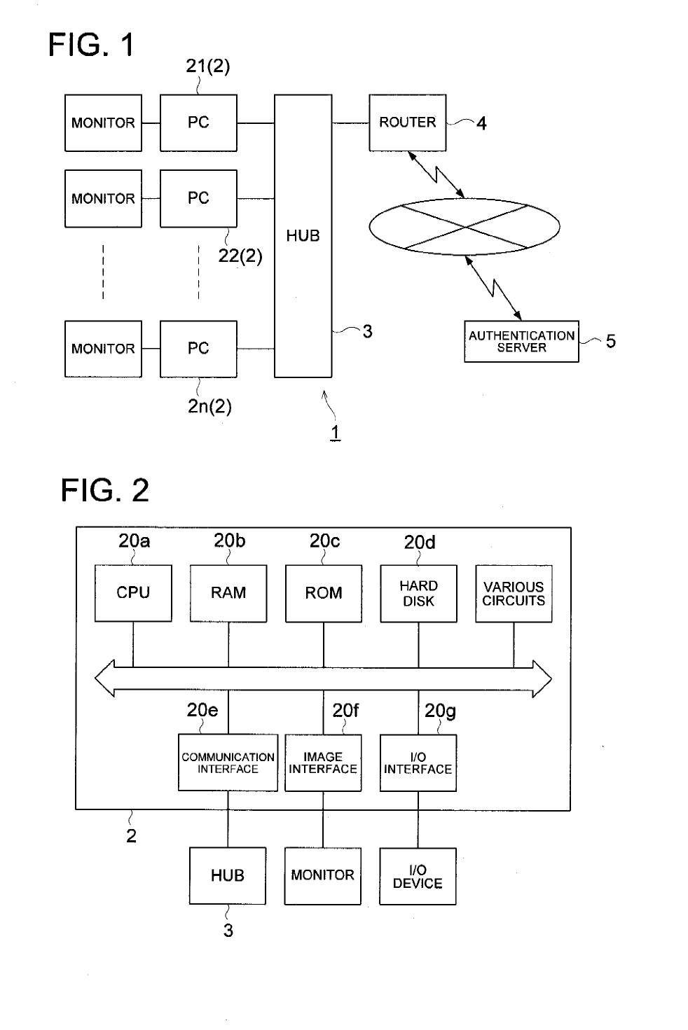

FIG. 1 is a drawing showing the entire constitution example of a network 1 composed of the encrypted communication processing method and encrypted communication processing apparatus according to the embodiment. By referring to FIG. 1, the entire constitution of the network 1 according to the embodiment of the present invention will be explained.

The network 1 according to the embodiment of the present invention, as shown in FIG. 1, is a LAN (local area network) composed of nodes such as a plurality of terminal devices 2 (21, 22, - - - , 2n), a switching hub 3, a router 4, and an authentication server 5. The terminal devices 2 are connected to the switching hub 3 by twisted pair cables in a star shape.

The terminal devices 2 as nodes constituting the network are an encrypted communication processing apparatus according to the present invention, which executes a data I/O process by encrypted communication between itself and another device such as a personal computer, a work station, or a printer. Hereinafter, a description will be made assuming that a node is just referred to as this terminal and a personal computer is used as the node.

Further, in this embodiment, a form of a communication network called a P2P (Peer to Peer) is adopted. The P2P is a form usage of a network for directly transmitting and receiving information between many and indefinite number of nodes, and there are two kinds of forms such as a form technologically requiring intermediation of a central server and a form for transferring data in a bucket brigade system. When the central server is required, it only provides a file search data base and controls connection of nodes, and transfer of data is executed through direct connection between the nodes.

Further, even in a form that the central server performs an integrated processing as a host, there is also a system which can be occasionally changed such that any client functions as the central server. Such a network can be seen to practically have the same function as the P2P system in which direct transmission and reception of data between indefinite number of nodes is executed.

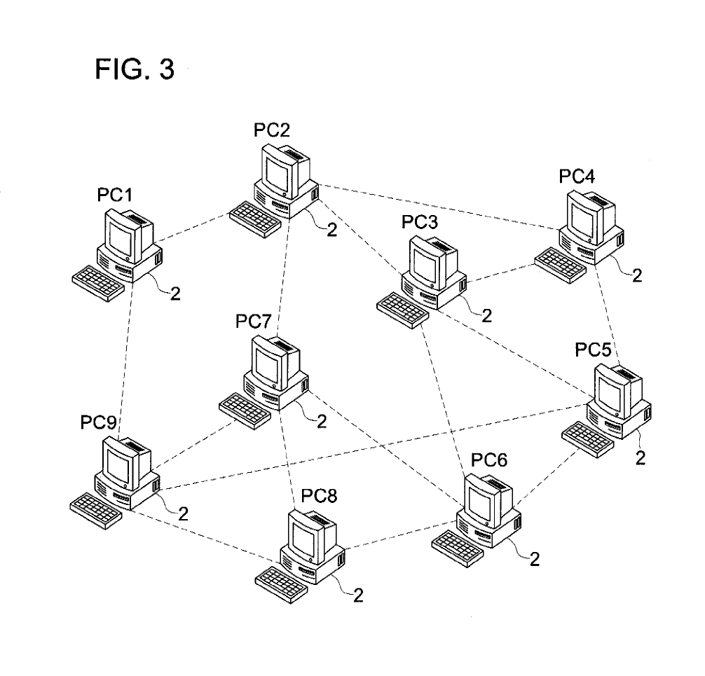

In this embodiment, the central server is not used, and the connection topology shown in FIG. 3 will be described later, where the direct connection and communication between the nodes (encrypted communication processing apparatuses) 2 associated with each other beforehand is executed. The connection between the nodes not associated with each other beforehand is to be established via the directly connected nodes. The authentication server 5 executes only the management related to a certificate for authentication and does not directly participate in the connection for communication. Further, also the router 4 does not participate in communication between the nodes (encrypted communication processing apparatuses).

In the P2P, because the nodes mutually execute communication directly, important is a security of verifying mutual justification in some way or decreasing room for unauthorized access. Therefore, a digital certificate issued by the authentication server 5 is used. In the encrypted communication processing which will be described later, the digital certificate of the specification X.509 is used. Regarding authentication using the digital certificate, refer to IETF RFC2459, “Internet X.509 Public Key Infrastructure Certificate and CRL Profile”.

If the validity of the digital certificate has expired or the reliability of the digital certificate is impaired due to loss or robbery of the secret key, the certificate authority posts it on the certificate revocation list (CRL) to open to the public, thus it looses its effect.

Hereinafter, on the network according to this embodiment, there is described, from the aforementioned viewpoint, the case in which these nodes 2 establish mutual connection for encrypted communication and mutually transmit and receive information by encryption.

### [Constitution of the Encrypted Communication Processing Apparatus]

FIG. 2 is a drawing showing an example of the hardware constitution of the node (encrypted communication processing apparatus) 2.

The node 2, as shown in FIG. 2, is composed of a CPU 20a, a RAM 20b, a ROM 20c, a hard disk 20d, a communication interface 20e, an image interface 20f, an I/O interface 20g, and other various circuits or devices.

The communication interface 20e is, for example, an NIC (Network Interface Card) and is connected to either port of the switching hub 3 via a twisted pair cable. The image interface 20f is connected to a monitor and sends a video signal for displaying to the monitor.

The I/O interface 20g is connected to an input device such as a keyboard or a mouse or an external storage device such as a CD-ROM drive. And the interface inputs from the input device a signal indicating the contents of the operation performed by a user to the input device. Or, the interface permits the external storage device to read the data recorded in the recording medium of the CD-ROM or the like and inputs it. Or, the interface outputs data to be written into the recording medium to the external storage device.

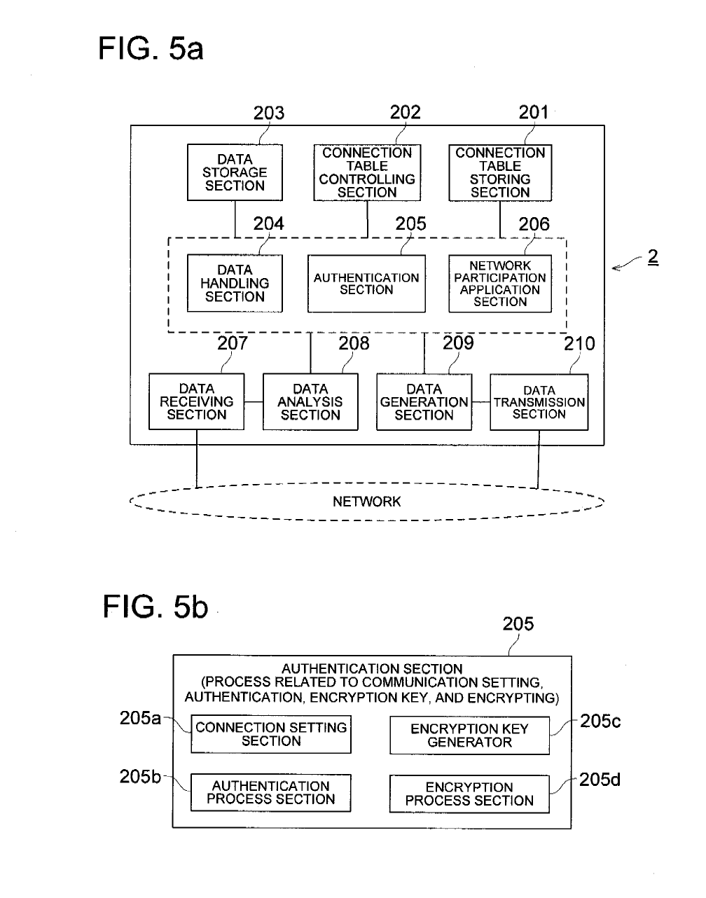

In the hard disk 20d, as will be described later by referring to the function block diagrams (FIGS. 5a and 5b), stored are the programs and data for realizing the functions of a connection table storing section 201, a connection table controlling section 202, a data storage section 203, a data handling section 204, a authentication section 205, a network participation application section 206, a data receiving section 207, a data analysis section 208, a data generation section 209, and a data transmission section 210 or the like. These programs and data are loaded into the RAM 20b as required, and the programs are executed by the CPU 20a.

To each of the nodes 2, for discrimination from the other nodes 2, the host name (machine name), IP address, and MAC address are given. The host name can be decided freely by the manager of the network 1. The IP address is given according to the regulations of the network 1. The MAC address is an address given fixedly to the communication interface 10e of the concerned node 2.

In this embodiment, to the nodes (encrypted communication processing apparatuses) 21, 22, - - - , the host names such as PC1, PC2, - - - are assumed to be assigned. Hereinafter, the nodes 2 may be mentioned by the host names.

### [Connection Form of the Nodes]

FIG. 3 is a drawing showing the connection form of the nodes, that is, a theoretical topology example of the nodes 2. The connection form of the nodes (encrypted communication processing apparatuses) will be described by referring to FIG. 3.

The nodes 2, as shown in FIG. 3, are assumed to be arranged in a virtual space. And, as shown by the dotted lines, each node is associated with at least another neighboring node in the virtual space. Moreover, by this association, all the nodes 2 are associated with each other directly or indirectly.

Further, “to be directly associated” is referred to as being coupled by single dotted line in FIG. 3 (for example, the relationship between PC1 and PC2 or PC9 shown in FIG. 3), and “to be indirectly associated” is referred to as being coupled via at least two dotted lines and one node (for example, the relationship between PC1 and PC4 shown in FIG. 3). The nodes 2 transmit data to other nodes 2 directly associated with themselves.

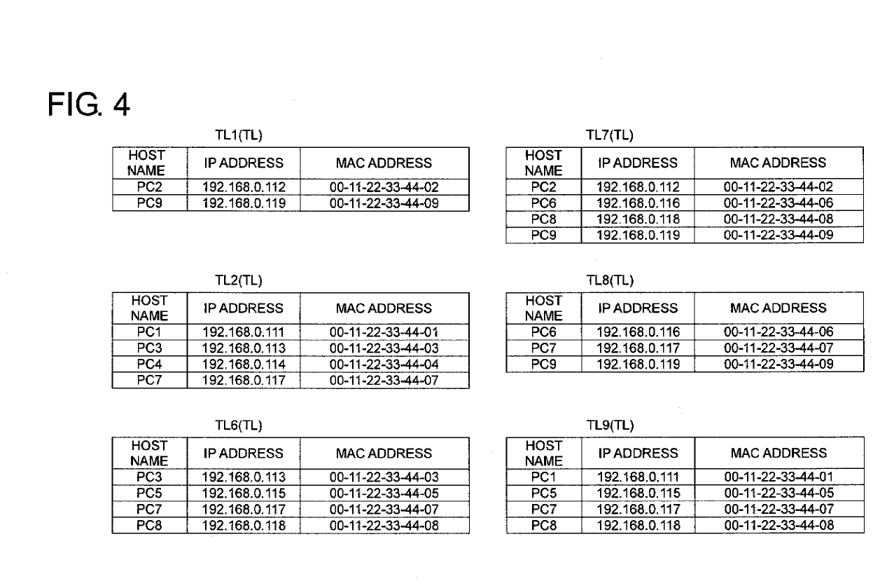

FIG. 4 is drawings showing the examples of the connection table TL of the nodes 2 associated as shown in FIG. 3. Each of the tables TL holds in table form a list of information for connection with other nodes 2 “associated directly” to which the each node can directly transmit data.

For example, in the PC1, PC2, PC6, PC7, PC8, and PC9 shown in FIG. 3, the connection tables TL1, TL2, TL6, TL7, TL8, and TL9 as shown in FIG. 4 are held respectively.

### [Function of Each Section of the Encrypted Communication Processing Apparatus]

FIG. 5a is a block diagram showing a functional constitution example of the node (encrypted communication processing apparatus) 2. The processing function of each section of the node 2 will be described by referring to FIG. 5a.

The connection table storing section 201 stores the connection table TL indicating a list of the attributes such as the host name, IP address, and MAC address of another node 2 with which the node 2 itself is directly associated. For example, an example of the connection table stored in the connection table storing section 201 of each node is described already by referring to FIG. 4. The contents of these connection tables TL are generated beforehand by the manager on the basis of the association of the respective nodes 2.

The connection table controlling section 202 controls the connection table TL stored in the connection table storing section 201 aforementioned.

The data storage section 203 stores attribute data indicating the attributes of the concerned node 2 or a user, data used in a digital certificate of the concerned node 2 itself, a certificate revocation list (CRL), data used in an operating system (OS) or application software, data generated by the user using the application software, data such as an encryption key necessary to perform the encrypted communication processing, and the other various data as a file.

The digital certificate is issued by the authentication server 5 upon request of a node 2, is stored by the concerned node 2, and is used to authenticate mutually at the time of communication of nodes 2. The certificate revocation list (CRL) registers and records the revocation of the digital certificate due to secession of the concerned node and is controlled by the authentication server 5.

The data handling section 204 stores data in the data storage section 203 and performs a process of updating the data stored in the data storage section 203. For example, whenever the environment of the node 2 or the setting contents thereof are changed, the data handling section 204 updates the attribute data.

Further, the data handling section 204 processes and temporarily stores data (information) acquired from other nodes.

The authentication section 205, on the basis of a digital certificate transmitted from another node 2, performs the authentication process for the concerned another node 2. Further, it inquires the authentication server 5 to confirm whether the transmitted digital certificate has been revoked or not.

Further, the authentication section 205 performs a process for establishment of encrypted communication with other nodes and a process for the encrypted communication. The details will be described later.

The network participation application section 206 performs a process for the concerned node 2 to newly participate in the network or to escape it.

The data handling section 204, authentication section 205, and network participation application section 206 execute, whenever necessary, data communication with other nodes 2 of the network 1 via the data receiving section 207 and data transmission section 210, and whenever necessary, refer to or update the data of the connection table storing section 201 and data storage section 203.

FIG. 5b is a drawing showing the internal constitution of the function of the authentication section 205. By referring to FIG. 5b, the function of the authentication section 205, that is, the functions of the processes for establishment of encrypted communication with other nodes and the encryption processing will be described.

The authentication section 205 includes a connection setting section 205a for functioning as a connection section for exchanging message numbers and an authentication process section 205b for functioning as an authentication section for transmitting and receiving information necessary to authenticate each node and authenticating it.

Further, the authentication section 205 includes an encryption key generator 205c for functioning as an encryption key generating section for transmitting and receiving information for generating an encryption key, for generating the encryption key, and for sharing it, and an encryption process section 205d for functioning as an encrypting section for executing data communication which is encrypted on the basis of the encryption key.

The functions of the connection setting section 205a, authentication process section 205b, encryption key generator 205c, and encryption process section 205d will be described in detail together with the encrypted communication processing flow to be described later.

By referring to FIG. 5a again, the description of each section of the node (encrypted communication processing apparatus) 2 will be continued.

The data receiving section 207 performs the control process for executing data communication with other nodes 2. The data receiving section 207, among the packets flowing in the network 1, receives ones necessary for the node 2.

The data analysis section 208, from the data received by the data receiving section 207, extracts necessary information, analyzes the contents thereof, thereby discriminates the kind of the received data.

The data generation section 209 generates transmission data to be transmitted to other nodes 2 on the basis of an instruction of the data handling section 204, authentication section 205, network participation application section 206 or the like.

The data transmission section 210 transmits transmission data which is generated and converted into packet by the data generation section 209 to other nodes 2.

### [Inter-Node SSL Communication]

Each of the nodes 2 of this embodiment uses a simplified communication protocol without establishing session such as the UDP to maintain high-speed communication between itself and another node 2 associated with directly or indirectly. For the detailed UDP, refer to IETF RFC768, “User Datagram Protocol”. Although his embodiment does not use SSL communication, the processing of connection establishment of the SSL communication will be first described because it is useful for understanding the flow of the process of establishing encrypted communication of this embodiment. Further, for further details of the SSL communication, refer to IETF RFC2246, “The TLS Protocol Version 1.0” and INTERNET-DRAFT, “The SSL Protocol Version 3.0”. In the following description of the SSL communication, a digital certificate will be called an X.509 certificate.

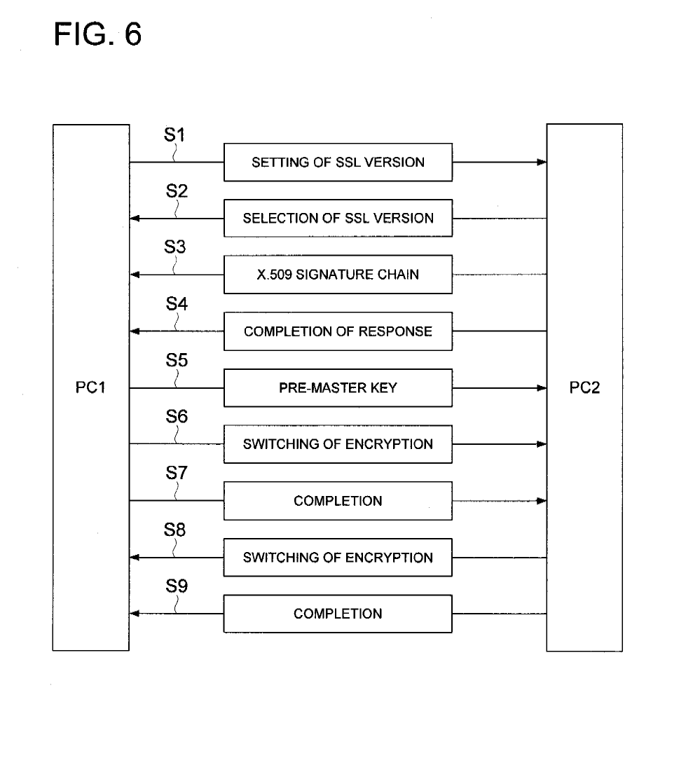

FIG. 6 is a drawing illustrating an example of the processing flow when establishing connection of the SSL communication in this embodiment. The case that the nodes shown in FIG. 3, for example, the PC1 and PC2 are about to execute the target communication will be described as an example in more detail by referring to FIG. 6.

As a preceding stage of connection establishment of the SSL communication, the connection itself is established. Firstly, it is assumed that a user inputs by operating the keyboard a command indicating, for example, that the PC1 is caused to communicate with the PC2. Then, the data generation section 209 generates connection request data, and the data transmission section 210 transmits the connection request data to the node PC2.

Then, in the PC2, the data receiving section 207 receives the connection request data from the PC1, and the data analysis section 208 analyzes the kind of the data. Here, needless to say, it is analyzed as connection request data. The data generation section 209 generates connection permission data indicating permission of connection, and the data transmission section 210 transmits it to the PC1.

The connection permission data is received by the data receiving section 207 of the PC1, and then the predetermined process is performed to establish the connection between the PC1 and the PC2. However, at this point of time, the connection of the SSL communication is not established yet, and then, the program enters the flow of connection establishment of the SSL communication.

Firstly, in either of the PC1 and PC2, the data generation section 209 generates SSL version data indicating the compatible versions of the SSL, and the data transmission section 210 transmits it to the other node (Step S1). In FIG. 6, it is assumed that the PC1 transmits the SSL version data to the PC2.

Then, in the PC2, the data receiving section 207 receives the SSL version data, and the data analysis section 208 analyzes the kind of the data, and the data generation section 209, among the versions indicated in the SSL version data, selects one version available in the PC 2 and generates SSL version selection data indicating it. And, the data transmission section 210 transmits it to the PC1 (Step S2).

When the SSL version selection data from the PC2 is received by the data receiving section 207, the PC1 decides to adopt an SSL of the versions indicated therein as a protocol for the target communication. The PC2 also decides similarly.

Next, the PC2 transmits the X.509 digital certificate to the PC1. If the X.509 digital certificate is not a one signed by the well-known authentication server 5, the PC2 transmits a chain of the certificates to the authentication server 5. The PC1 stores beforehand a route certificate for verifying the authentication server 5 itself and verifies whether there is the signed X.509 certificate received from the PC2 in it or not. Further, the PC1 confirms whether the concerned certificate is recorded in the certificate revocation list (CRL) issued by the authentication server 5 having signed it or not, and if it is recorded there, the communication is terminated at that time (Step S3).

If the authentication process aforementioned is cleared, thereafter, the PC2 notifies the PC1 of completion the response (Step S4).

Upon receipt of the notification of completion of the response from the PC2, the PC1 generates a pre-master key having a random value of 384 bits to generate a shared key to be used in the SSL communication. The data generation section 209 of the PC1 encrypts the pre-master key by the public key of the PC2 included in the X.509 certificate received from the PC2 and transmits it to the PC2 (Step S5).

Further, the PC1, on the basis of the pre-master key, generates a shared key to be actually used for encryption of data and controls so as to switch the encryption key for communication to the shared key. Further, the PC1 transmits to the PC2 an encryption switching notification indicating switching of the encryption key (Step S6).

Upon receipt of the notification of completion of switching the encryption key from the PC1 (Step S7), the PC2 also transmits the notification of switching the encryption key to the PC1 to switch the encryption key (Step S8). The data receiving section 207 of the PC2 decodes the pre-master key encrypted by its own public key which is received from the PC1 by the corresponding own secrete key. When the data analysis section 208 analyzes it, thereby confirms that the data kind is a pre-master key, the data handling section 204 generates a shared key on the basis of the received pre-master key, and hereafter, controls so that encrypted communication by the shared key is executed between itself and the PC1. Namely, the encryption key is switched.

When the encryption key is finished in switching, the PC2 transmits the notification of completion of switching of an encryption key to the PC1 (Step S9).

By the aforementioned processes, the connection of the SSL communication is established between the PC1 and the PC2. By doing this, the target communication can be executed safely.

Further, in the connection establishment aforementioned, although the case that the X.509 certificate of the PC2 is confirmed by the PC1 is described, there is a case that the X.509 certificate of the PC1 is confirmed simultaneously by the PC1. This is called SSL client authentication communication.

To execute the SSL client authentication communication between the PCs and between the PCs and the authentication server, each node needs to have the X.509 certificate and also needs to have a route certificate to verify the certificate.

As described above, the nodes 2 of the network 1 can perform the operation of communicating safely as nodes mutually verified.

### [Encrypted Communication Processing]

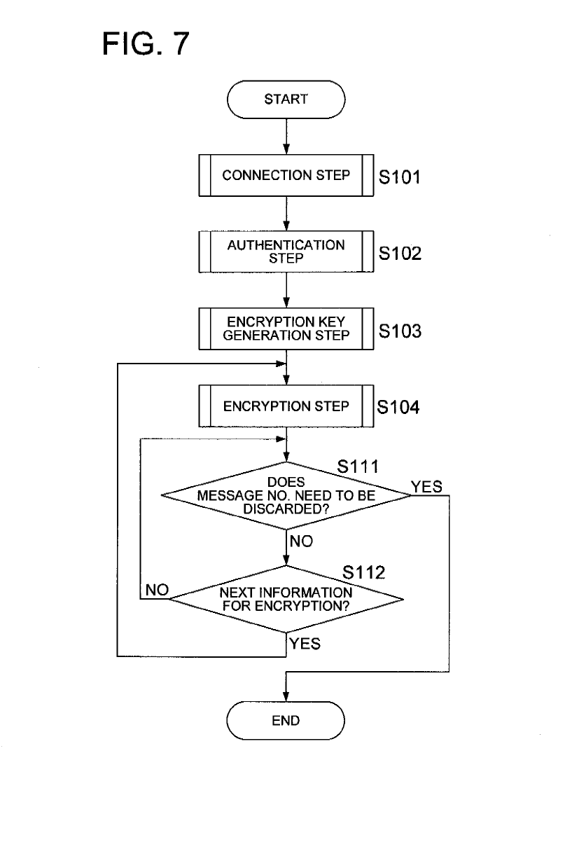

As already described, the nodes 2 of this embodiment are supposed to take a simple communication form such as the UDP without establishing sessions to maintain high-speed communication between nodes 2 directly or indirectly associated. The flow of the encrypted communication processing of this embodiment for maintaining such a simple procedure and establishing encrypted communication will be described below by referring to FIG. 7.

FIG. 7 is a flow chart showing the flow of the encrypted communication processing method of this embodiment.

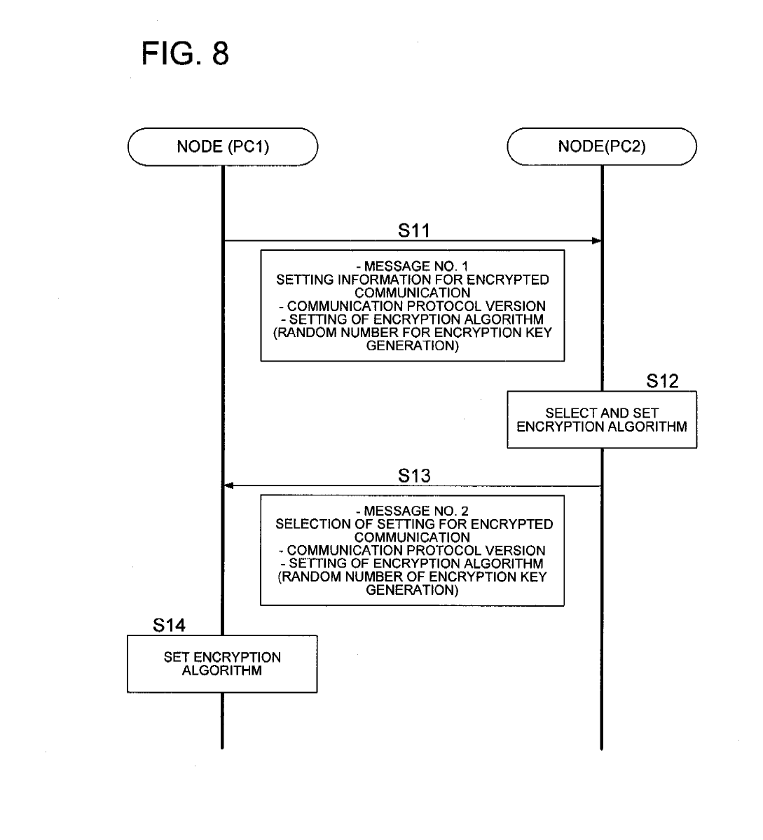

Step S101 shown in FIG. 7 is a connection step, and the message numbers are exchanged in the step. Using as an example the case where the node PC1 is to communicate with the node PC2, the connection step will be described in detail by referring to FIG. 8.

### [Connection Step]

FIG. 8 shows the flow of the detailed process at the connection step at Step S101 shown in FIG. 7. The connection step is executed by the connection setting section 205a functioning as a determination section of the authentication section 205.

Firstly, at Step S11 shown in FIG. 8, the connection setting section 205a starts the processing for encrypted communication establishment. The PC1 transmits a message including a message number (hereinafter, may be referred to as message No.) and setting information for encrypted communication to the PC2. By doing this, between the PC1 and the PC2, the message number is determined.

The setting information for encrypted communication includes the version of the communication protocol and settings concerning the encryption algorithm. In the settings concerning the encryption algorithm, the information (random numbers for encryption key generation, etc.) necessary to generate an encryption key from the pre-master key which will be described later is included.

The message No. is a number assigned to all messages transmitted from the PC1 until it is destroyed as described later, and the message No. is assumed as 1 here. Therefore, after reception of the message No. 1, the PC2 confirms the message No. assigned to a received message, and if it is the message No. 1, the PC2 finds that the message is transmitted from the PC1. Therefore, this eliminates the handshaking every time when a message is transmitted or received.

After receiving the setting information for encrypted communication, at Step S12, the PC2 selects and sets a version which is available in the PC2 on the basis of the version data of the received communication protocol. Further, the PC2 selects and sets the algorithm supported by the PC2 on the basis of the received setting of the encryption algorithm.

At Step S13, the PC2 transmits a message including the setting and selection for encrypted communication to the PC1. As setting and selection for encrypted communication, the version of the selected communication protocol and setting information of the encryption algorithm are included. And, the message is attached with the message No.

The reason of attachment of the message No. is the same as the reason of attachment of message No. 1 to a transmission message of the PC1, and the message number is assumed as 2 here. Hereinafter, to all messages transmitted from the PC2, the message No. 2 is attached. Similarly to the message No. 1 of the PC1, by the message No. 2 assigned to a message, it is found that the message is a one transmitted from the PC2.

The message No. is desirably a unique number for each transmission node. Or, the message No. may be unique for each combination of nodes to be transmitted to or received from. In this case, the same message No. 1 is assigned to both transmission from the PC1 to the PC2 and transmission from the PC2 to the PC1, and both PC1 and PC2 can identify the node of the transmission source from the message No. 1. The point is that it is enough that a specific message number is determined between the PC1 and the PC2.

At Step S14, after receiving the setting and selection for encrypted communication, the PC1 sets the version to be used by the PC1 on the basis of the version setting of the received communication protocol. Further, the PC1 sets the algorithm of the PC1 on the basis of the setting of the received encryption algorithm. Further, the PC1 stores the message No. 2 for the subsequent encrypted communication as a number representative of the transmission message from the PC2.

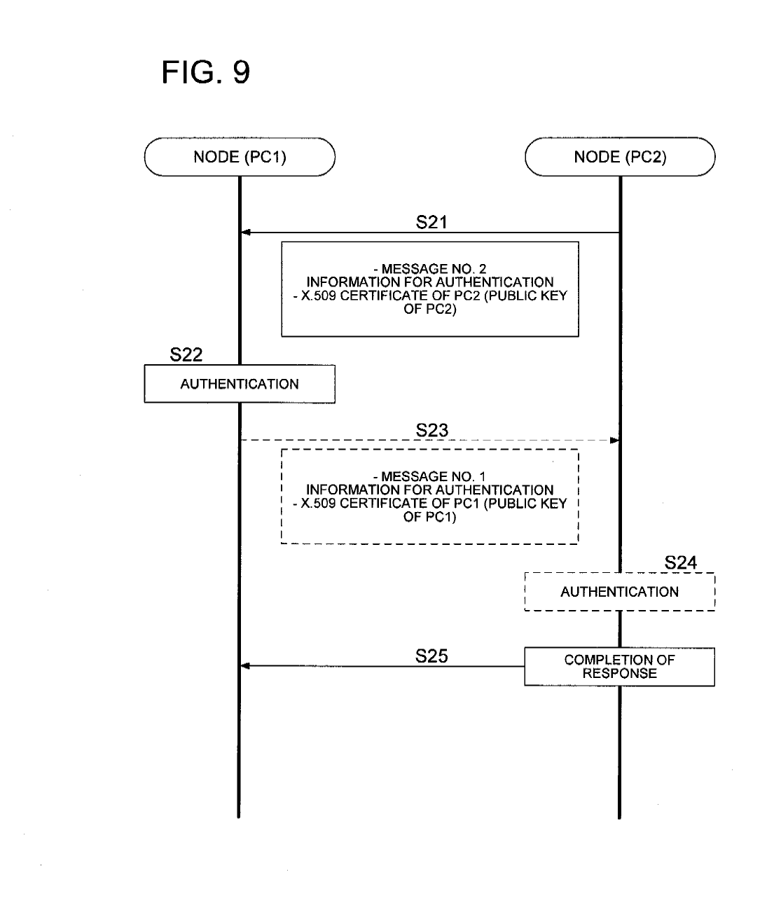

The description will return to FIG. 7. Step S102 following the connection step at Step S101 is an authentication step, in which the information necessary to authenticate each node is transmitted and received to authenticate each node. Using as an example the case where the node PC1 is to authenticate the node PC2, the authentication step will be described in detail by referring to FIG. 9.

### [Authentication Step]

In FIG. 9, the flow of the detailed process at the authentication step at Step S102 shown in FIG. 7 is shown. The authentication step is executed by the authentication process section 205b of the authentication section 205.

At Step S21 shown in FIG. 9, firstly, the PC 2 transmits a message including information for authentication to the PC1 together with the message No. 2 of the PC2. The information for authentication is the X.509 digital certificate of the PC2 including the information of the public key of the PC2.

The public key is used to transfer and receive safely the pre-master key at the next encryption key generation step. The reason of transmission of the X.509 certificate and the authentication method by the certificate are the same as those of the SSL communication already described. If the X.509 certificate is not a one signed by the well-known authentication server 5, the chain of the certificates to the authentication server 5 is also transmitted.

At the next Step S22, the PC2 is verified on the basis of the X.509 certificate received by the PC1.

The PC1 stores beforehand a route certification for authenticate the authentication server 5 itself and verifies whether there is the signed X.509 certificate received from the PC2 in it or not. Further, the PC1 confirms whether the concerned certificate is recorded in the certificate revocation list (CRL) issued by the authentication server 5 having signed it or not, and when it is recorded, the communication is terminated at that time.

In the above description, although the PC1 authenticates the PC2 on the basis of the X.509 certificate of the PC2, the PC2 also may authenticate mutually on the basis of the X.509 certificate of the PC1. In this case, the nodes must have the X.509 certificates and the route certificates for verifying the respective certificates.

The next Steps S23 and S24 may be omitted. They are steps at which the PC2 authenticates the PC1.

At Step S23, this time, the PC1 transmits a message including the information for authentication to the PC2 together with the message No. 1 of the PC1. The information for authentication is similarly the X.509 digital certificate of the PC1 including the information of the public key of the PC1.

The public key is used to transmit and receive safely the pre-master key at the next encryption key generation step. If the X.509 certificate is not a one signed by the well-known authentication server 5, the chain of the certificates to the authentication server 5 is also transmitted.

At the next Step S24, the PC1 is verified on the basis of the X.509 certificate received by the PC2. The authentication method is the same as the authentication of the PC2 by the PC1 (Steps S21, S22).

At Step S25, after finishing the authentication process aforementioned, the PC2 notifies the PC1 of completion of the response. Upon receipt of the notification of completion of the response of the PC2, the PC1 starts the next encryption key generation step.

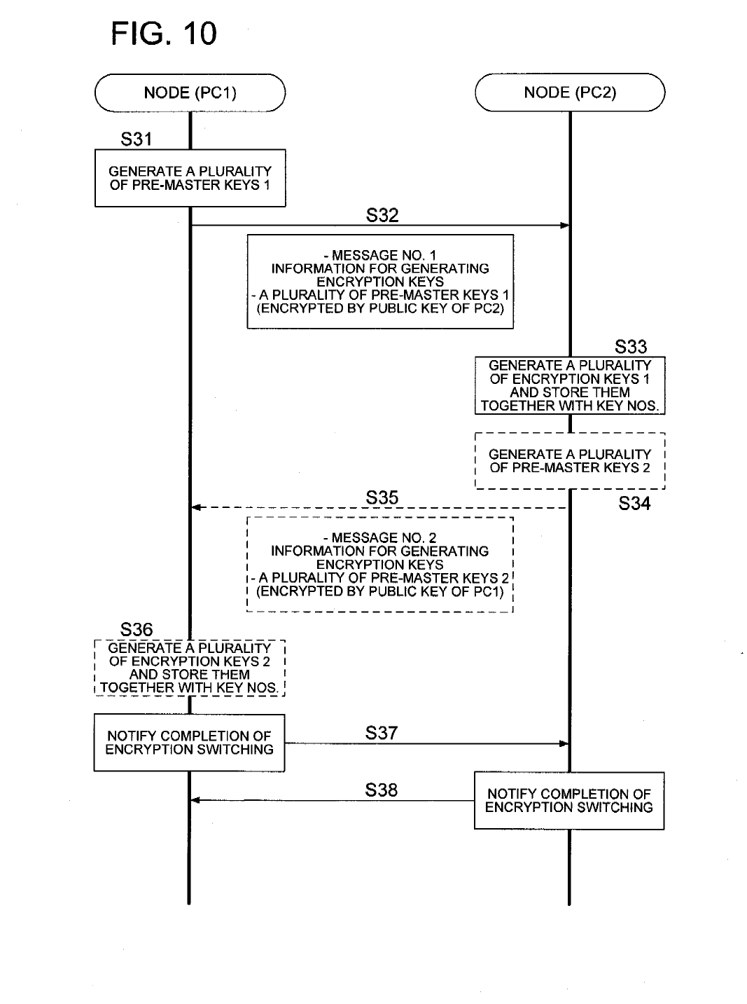

The description will return to FIG. 7. Step S103 following the authentication step at Step S102 is a step of encryption key generation, in which the information for generating an encryption key is transmitted and received and the encryption key is generated and shared. Using as an example the case where an encryption key as a shared key is generated and shared when the node PC1 executes encrypted communication with the node PC2, the encryption key generation step will be described in detail by referring to FIG. 10.

### [Encryption Key Generation Step]

FIG. 10 shows the flow of the detailed processing at the encryption key generating step at Step S103 shown in FIG. 7. The encryption key generating step is executed by the encryption key generator 205c of the authentication section 205.

At Step S31 shown in FIG. 10, firstly, the PCd generates a plurality of random pre-master keys for generating a plurality of encryption keys. Using the pre-master keys and the information of random numbers for encryption key generation included in the setting information for the encrypted communication transmitted at the connection step, encryption keys are generated.

Here, as a plurality of pre-master keys, pre-master keys 1-1, 1-2, and 1-3 are assumed to be generated. The pre-master keys are transmitted to the PC2, and the PCd and PC2 are supposed to generate and share the same encryption keys (shared keys) 1-1, 1-2, and 1-3.

At the next Step S32, the PCd transmits a message including the information for generating an encryption key to the PC2 together with the message No. 1 of the PC1. The information for generating an encryption key includes the plurality of pre-master keys 1-1, 1-2, and 1-3 generated at Step S31.

The plurality of pre-master keys are encrypted each using the public key of the PC2 as a transmission destination. The public key of the PC2 is included in the information for authentication of the PC2 which is acquired by the PC1 at the authentication step.

At Step S33, the PC2 decrypts the plurality of pre-master keys 1-1, 1-2, and 1-3 which are received by the PC2 (encrypted by the public key of the PC2 itself) using the secrete key stored in the PC2 itself. Furthermore, on the basis of the decrypted plurality of pre-master keys 1-1, 1-2, and 1-3 and the random numbers for encryption key generation received from the PC1 at the connection step of Step S1, the PC2 generates encryption keys 1-1, 1-2, and 1-3.

The generated plurality of encryption keys are used both for encryption and decryption, and the same keys are held in the PC1 and PC2, and hereinafter may be referred to as a shared key group (shared keys 1-1, 1-2, and 1-3). Needless to say, also in the PC1, using the same pre-master keys and the random numbers for encryption key generation, the same shared key group (shared keys 1-1, 1-2, and 1-3) is generated and shared by the PC2.

The shared key group (shared keys 1-1, 1-2, and 1-3) is shared with the PC2 and PC1 and stored in the respective data storage sections 203 associated with the message No. 1 assigned to the pre-master keys which are the bases of the shared keys.

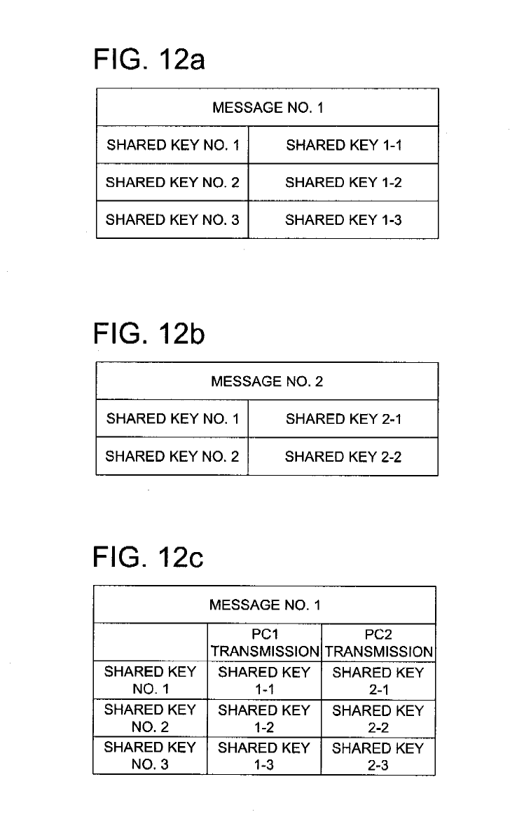

In FIG. 12a, the situation that the message No. and the shared key group (shared keys 1-1, 1-2, and 1-3) are stored in the data storage section 203 as a memory section is shown schematically. The PC1, when transmitting the message, designates the message No. (specifically the transmission source of encrypted communication, PC1 in this case) and the shared key No., thereby can identify and refer to the shared key used for encryption. Further, the PC2, when receiving the message, can identify and refer to the shared key to be used for decryption since the message No. (similarly, the transmission source of encrypted communication, that is, PC1) and shared key No. are designated.

Further, in the above description, although described is the case where the PC1 and PC2 generate the same shared keys by the same plurality of pre-master keys and the random numbers for encryption key generation, only one of the nodes may generate the encryption key. In that case, the shared key group is generated, for example, by the PC2 using the public key of the PC1, and the shared key group may be returned to the PC1 together with the message No. to be decrypted by the PC1, thus both nodes may share the same shared key group.

In the above description, the PC1 transmits the information for generating the encryption key to the PC2 and permits the PC2 to generate a shared key group for encrypted communication from the PC1 to the PC2. Although the same shared key group may be used for encrypted communication from the PC2 to the PC1, it is also possible to use a shared key group different from that for the encrypted communication from the PC1 to the PC2 to improve the security. For example, there can be added a procedure where information for generating an encryption key is transmitted from the PC2 to the PC1 to generate another shared key group for encrypted communication from the PC2 to the PC1.

Namely, the subsequent Steps S34, S35, and S36 are reverse steps of the Steps S31, S32, and S33 aforementioned, and higher security can be obtained by use of different keys for transmission and return. Those steps may be omitted, and in such a case, the aforementioned shared key group (shared keys 1-1, 1-2. and 1-3) is also used in the encrypted communication from the PC2 to the PC1.

At Step S34, similarly to Step S31, the PC2 generates a plurality of random pre-master keys for generating a plurality of encryption keys.

Here, pre-master keys 2-1 and 2-2 are assumed to be generated as a plurality of pre-master keys. The pre-master keys are to be transmitted to the PC1, and the PC1 and PC2 are to generate and share the same encryption key group (shared keys) 2-1 and 2-2.

At the next Step S35, the PC2 transmits a message including the information for generating encryption keys to the PC1 together with the message No. 2 of the PC2. The information for generating encryption keys includes the plurality of pre-master keys 2-1 and 2-2 generated at Step S34.

Further, similarly to Step S32, the plurality of pre-master keys are encrypted each using the public key of the PC1 which is a transmission destination. The public key of the PC1 is included in the information for authentication of the PC1 which is acquired by the PC2 at the authentication step.

At Step S36, the PC1 decrypts the plurality of pre-master keys 2-1 and 2-2 (encrypted by the public key of the PC1 itself) received by the PC1 using the secrete key stored by the PC1 itself. Furthermore, the PC1 and PC2 generate the shared keys 2-1 and 2-2 on the basis of the decrypted plurality of pre-master keys 2-1 and 2-2 and the aforementioned random number for encryption key generation.

Needless to say, also in the PC2, the same shared key group (shared keys 2-1 and 2-2) is generated using the same pre-master keys and the random numbers for encryption key generation. Or, as mentioned above, it is possible to generate a shared key group by only one of the nodes, for example, only by the PC1, and to transmit it by encryption from the PC1 to the PC2 to share it.

The generated shared key group (shared keys 2-1 and 2-2) is associated with the message No. 2 attached to the pre-master keys which are the bases for the shared key, thereby, is stored and shared in each of the data storage sections 203 of the PC1 and PC2.

In FIG. 12b, the situation that the message No. 2 and the shared key group (shared keys 1-1, 1-2, and 1-3) are stored in the data storage section 203 as a memory section is shown schematically. The PC2, when transmitting the message, designates the message No. (specifically the transmission source of encrypted communication, PC2 in this case) and the shared key No., thereby the PC2 can identify and refer to the shared key to be used for encryption. Further, when receiving the message, because the message No. (similarly, the transmission source, that is, PC2) and shared key No. are designated, the PC1 can identify and refer to the shared key to be used for decryption.

In the above description, the form where different encryption keys are shared depending on the transmission direction between the PC1 and the PC2 is adopted, and for that purpose, the PC1 and PC2 use different pre-master keys. However, it is possible to use the same pre-master key and to generate different encryption keys by using different random numbers for encryption key generation.

In this case, the same pre-master key is used, and Steps S34 and S35 aforementioned are unnecessary. In place of them, at Step S36, the PC1 generates each of the encryption keys 2-1, 2-2, and 2-3 on the basis of the plurality of pre-master keys 1-1, 1-2, and 1-3 and the random numbers for encryption key generation (different from the random numbers used by the PC2 at Step S33) received from the PC2 at the connection step at Step S13.

These encryption keys 2-1, 2-2, and 2-3, of course, are generated also in the PC2, or they are transmitted from the PC1 to the PC2, and they are stored in each of the data storage sections 203 of the PC1 and PC2 and shared as a shared key group (shared keys 2-1, 2-2, and 2-3).

In FIG. 12c, the situation that the message No. and shared key group (shared keys 2-1, 2-2, and 2-3) are stored in the data storage sections 203 as a memory section is shown schematically. However, the message No. is set so as to be unique by a combination of nodes transmitting and receiving mutually, and is assumed as message No. 1 for the transmission and reception between the PC1 and PC2.

The PC2, when transmitting the message, designates the message No. 1 (because the transmission destination is the PC1) and the shared key No. (for example, No. 3), and the PC2 can identify and refer to the shared key (for example, the shared key 2-3) used for encryption. On the other hand, the PC1, when receiving the message, designates the message No. 1 (because the transmission destination is the PC1 similarly) and the shared key No. (similarly No. 3), and the PC1 can identify and refer to the shared key (similarly the shared key 2-3) to be used for decryption.

Next, at Step S37, the PC1 controls so as to switch the encryption key for communication to the shared keys generated as mentioned above. Further, the PC1 transmits an encryption switching notification for indicating switching of the shared key for communication to the PC2. Further, when the shared key switching aforementioned is finished, the PC1 transmits the notification of completion of switching an encryption to the PC2.

Upon receipt of the notification of completion of the encryption switching from the PC1, also the PC2, in order to switch the encryption key, transmits the notification of switching an encryption to the PC1 and switches the shared key to be used for encrypted communication. Further, when the shared key switching is completed, the PC2 transmits the notification of completion of switching an encryption to the

Due to the aforementioned completion of encryption switching, the PC1 finishes the establishment of encrypted communication and starts the encrypted communication processing of actual transmission of data.

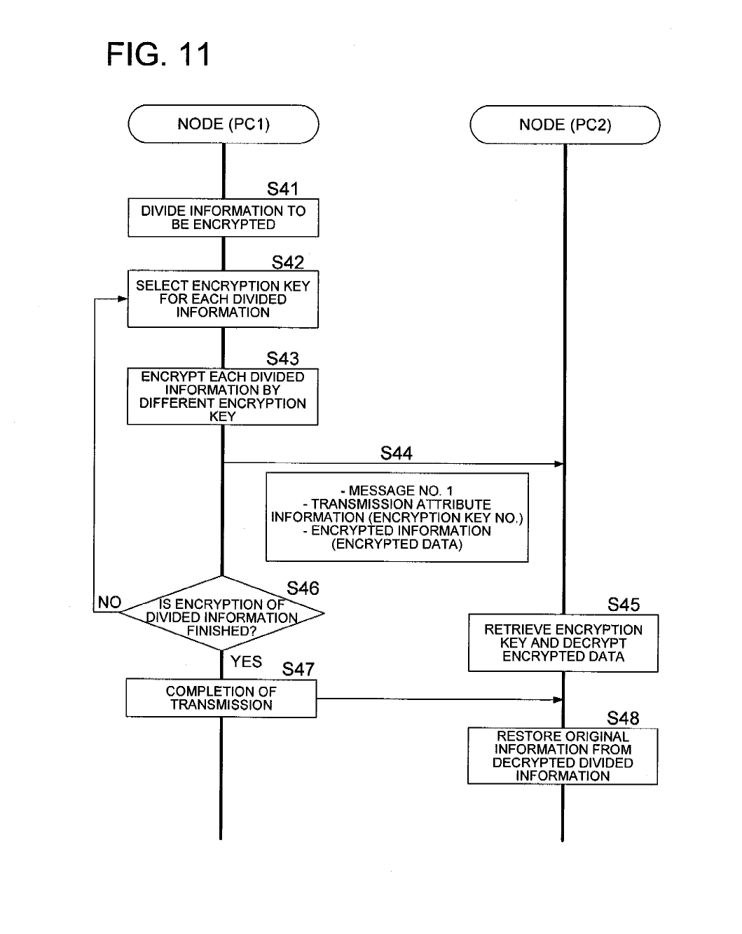

The description will return to FIG. 7. The Step S104 following the encryption key generating step at Step S103 is an encryption step and executes data communication encrypted on the basis of the encryption keys. Using as an example the case where the node PC1 transmits encrypted data to the node PC2, the encryption step will be described in detail by referring to FIG. 11.

### [Encryption Step]

FIG. 11 shows the flow of the detailed processing at the encryption step at Step S104 shown in FIG. 7. The encryption step is executed by the encryption process section 205d of the authentication section 205.

At Step S41 shown in FIG. 11, firstly, the PC1 divides data to be encrypted and transmitted into a plurality of data sets by an existing method. Here, it is assumed to be divided into three data sets of data set 1, data set 2, and data set 3. The reason of division into a plurality of data set is to change the encryption key for each divided data set and improve the security.

Next, at Step S42, the PC1 selects an encryption key associated with the message No. 1 of the PC1 at random for each of the divided data set. By doing this, the encryption key is switched for each data set. Here, for the data set 1, data set 2, and data set 3, shared key No. 3, shared key No. 1, and shared key No. 2 are assumed to be selected respectively. The respective shared keys are referred to (refer to FIG. 12a) from the data storage section 203.

Next, at Step S43, the PC1 performs the encryption process using the shared keys for each of the divided data sets respectively. Namely, the data 1, data 2, and data 3 are encrypted by the shared key No. 3, shared key No. 1, and shared key No. 2 respectively.

Next, at Step S44, the PC1 transmits the data set as the encrypted information to the PC2 together with the message No. 1 of the transmission source PC1 for each encrypted data. The transmission here may be a simple communication protocol such as the UDP. The encryption keys have been shared beforehand, so that there is no need for the handshaking which causes a reduction in the communication speed, and high-speed communication can be maintained.

The encrypted information to be transmitted includes the encrypted data set and the transmission attribute information attached therewith, and the transmission attribute information is the number of the encryption key (for example, for the data set 1, the shared key No. 2) having been used for encryption of the data. The size of the encrypted information is desirably less than the size which can be transmitted at a time by the protocol used for transmission such as the UDP.

At Step S45, the PC2 searches the data storage section 203 based on the transmission attribute information (encryption key number) of the received encrypted information and the message No. and identifies and refers to the shared key having been used for the encryption process of the data set. For example, when the encrypted data set 1 is received, the PC retrieves the shared key 1-2 based on the assigned message No. 1 and encryption key number (the shared key No. 2).

The PC2, using the shared key retrieved in this way, decrypts the encrypted data (the data set 1 in this case) included in the received encrypted information.

At Step S46, the PC1 judges whether the divided encrypted data sets are all transmitted or not based on the encrypted information transmitted immediately before. In the examples described so far, the PC1 judges whether the data sets up to the data set 3 have been transmitted or not.

If the divided data sets are all encrypted and transmitted (YES at Step S46), the PC1 executes Step S47. Namely, the PC1 informs the PC2 of completion of transmission.

If there are divided data sets which are not yet encrypted and transmitted (NO at Step S46), the PC1 returns to Step S42 and performs the aforementioned process for the next divided data set. At Step S46, until all the divided data sets are judged to be encrypted and transmitted, the processes from Step S42 to Step S46 are repeated.

When the PC2 receives a notification of completion of transmission at Step S47, the PC2 restores the original information which is divided and encrypted by the PC1 from all the divided data sets which are received and decrypted at Step S48.

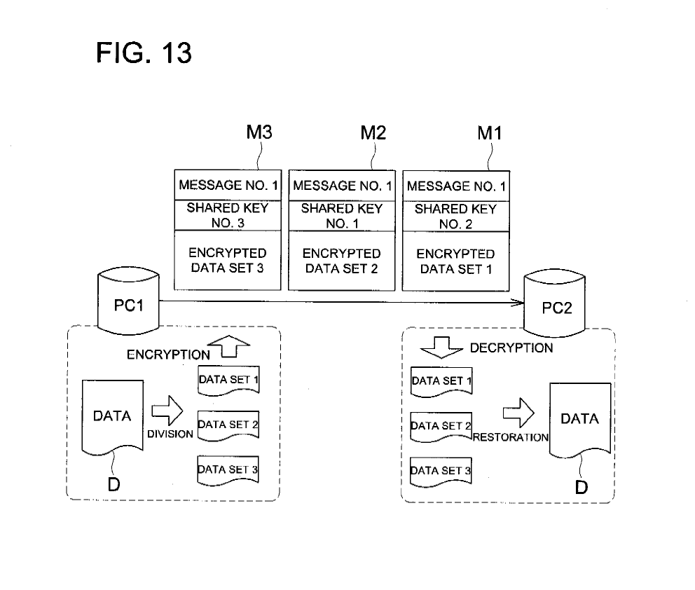

FIG. 13 is an illustration showing an example of actual data transmission by the encrypted communication processing.

Data D, in the node PC1, is divided into data set 1, data set 2, and data set3, which are encrypted by the shared keys No. 2, No. 1, and No. 3 respectively and are transmitted sequentially to the PC2 as encrypted information M1, M2, and M3.

Each of the encrypted information M1, M2, and M3 is composed of the message No., encrypted data, and transmission attribute information (including the encryption key No.).

In the node PC2, the received encrypted information M1, M2, and M3 are decrypted sequentially using the shared keys retrieved on the basis of the respective transmission attribute information, and the original data D is restored from the decrypted data set 1, data set 2, and data set 3.

The description will return to FIG. 7. When the encryption step at Step S104 is finished, the apparatus only waits for the next chance of encrypted communication. In this embodiment, a plurality of encryption keys are set beforehand, and the encryption key is selected in those encryption keys for each divided data set to be encrypted, thus the performance is prevented from lowering due to handshaking, and improvement of the security is realized. However, whole the plurality of encryption keys which are set beforehand and shared are renewed at appropriate timing, thus the security can be further improved. For that purpose, at the timing of completion of encryption step of Step S104, adopted is a processing procedure where it is checked whether the plurality of shared encryption keys should be renewed.

### [Re-Establishment Process of Encrypted Communication]

At Step S111, the PC1 decides whether or not to discard the message number. Discard of the message No. is to discard the encryption key associated with the message number. To perform a new encrypted communication processing, it is necessary to start again from the connection step and try again from the operation of setting a new message number.

Whether or not to discard the message No. is judged depending on whether the predetermined conditions are satisfied or not. The conditions for deciding the timing of discard may be considered as follows.

1. When a predetermined time period has passed after the aforementioned handshaking for establishment of encrypted communication, the message number is discarded.

2. When the power source of the PC1 is turned off, the message number is discarded.

3. When the connection with the corresponding PC of handshaking is interrupted, the message number is discarded.

4. When the encryption of the corresponding PC of handshaking cannot be decrypted, the message number is discarded.

5. The message number is discarded by an instruction of a user.

It is desirable to select and set appropriate conditions from the above conditions or other conditions.

When discard is decided in view of the set conditions (YES at Step S111), the setting of encrypted communication established by the above processing is once finished. When the situation of encrypted communication is to be performed again, the aforementioned establishment of encrypted communication is tried again from the Start shown in FIG. 7. Namely, when the aforementioned set conditions are satisfied, the encryption keys need to be generated again for security.

When non-discard is decided in view of the set conditions (NO at Step S111), the process goes to Step S112 and waits for transmission data for encryption. Namely, at Step S112, the it is decided whether there is the next transmission data to be encrypted or not, and when there is (YES at Step S112), the process returns to Step S104 and repeats the processing from the encryption step.

If there is not the next transmission data to be encrypted (NO at Step S112), the process returns to Step Sill to repeat Steps S111 and S112 and waits for the next transmission data for encryption while checking whether it is the timing of discard of the message number.

As mentioned above, by performing again the handshaking, that is, changing the encryption key itself in appropriate timing, the security can be further improved.

In the embodiment aforementioned, in the inter-node communication on the network, by setting a plurality of shared encryption keys first and arbitrarily switching them for each packet to be transmitted, there is no need to repeat the handshaking for changing, whenever needed, the encryption keys to be used. Therefore, effective encrypted communication with the improved security can be executed without decreasing the speed of communication.

Further, the scope of the present invention is not limited to the embodiment aforementioned. Without departing from the spirit of the present invention, modified embodiments are included within the scope.

What is claimed is:

1. A method for encrypted communication process for performing encrypted communication between a plurality of nodes constituting a network system, the method comprising the steps of:
determining a message number between a first node and the second node;
causing the first node to authenticate the second node;
communicating a first information for generating an encryption key between the first node and the second node when the first node has successfully authenticated the second node;
generating a plurality of encryption keys based on the first information to share the encryption keys between the first node and the second node;
causing the first node to encrypt a second information based on an encryption key selected from the plurality of the encryption keys and to transmit to the second node a message and the message number, the message including the encrypted second information; and
causing the first node to change the encryption key for encryption.

2. The method of claim 1, wherein the encrypted second information is provided with a transmission attribution information for identifying the encryption key used for the encryption of the second information.

3. The method of claim 1, wherein the message number is uniquely determined for each transmitting node or each combination of a transmitting node and a receiving node.

4. The method of claim 1, wherein the message number is discarded at a predetermined timing, and another message number is determined for a next communication.

5. The method of claim 1, wherein the second node transmits a certificate for authentication to the first node.

6. The method of claim 5, wherein the certificate includes a public key corresponding to a secret key held by the second node, and the first information for generating the encryption key is encrypted by the public key and transmitted from the first node to the second node.

7. The method of claim 1, where the plurality of encryption keys are stored in a memory section in correspondence with the message number.

8. An encrypted communication processing apparatus as a node of a network system for performing encrypted communication between a plurality of nodes, the apparatus comprising:
a determination section which is adapted to determine a message number between the apparatus and another node;
an authentication section which is adapted to authenticate the another node based on a first information received from the another node;
an encryption key generating section which is adapted to, when the another node has been successfully verified, communicate a second information for generating an encryption key to the another node, to generate a plurality of encryption keys based on the second information, and to share the encryption keys between the apparatus and the another node;
an encrypting section which is adapted to encrypt a third information based on an encryption key selected from the plurality of encryption keys shared between the apparatus and the another node, and to transmit a message and the message number to the another node, the message including the encrypted third information;
a change section which is adapted to change the encryption key used for encryption by the encrypting section.

9. The encrypted communication processing apparatus of claim 8, wherein the encrypting section provides the encrypted third information with a transmission attribute information for identifying the encryption key used for the encryption of the third information.

10. The encrypted communication processing apparatus of claim 8, wherein the determination section determines a unique value as the message number between the apparatus and the another node.

11. The encrypted communication processing apparatus of claim 8, wherein the determination section discards the message number at a predetermined timing, and determines another message number when another communication with the another node is to be performed.

12. The encrypted communication processing apparatus of claim 8, wherein the authentication section receives from the another node a certificate for authentication of the another node from.

13. The encrypted communication processing apparatus of claim 12, wherein the certificate includes a public key corresponding to a secret key held by the another node, and the encryption key generating section encrypts the second information for generating the encryption key by using the public key and transmits the encrypted second information from to the another node.

14. The encrypted communication processing apparatus of claim 8, comprising:
a memory section which is adapted to store the plurality of encryption keys in correspondence with the message number.
